(19) United States
(12) Patent Application Publication
(10) Pub. No.: US 2021/0162839 A1
(43) Pub. Date: Jun. 3, 2021

(54) DEVICE FOR A VENTILATION SYSTEM

(71) Applicant: Rheinmetall Landsysteme GmbH, Unterluess (DE)

(72) Inventors: Armin STAMM, Martensrade (DE); Eckhard SCHWARTZ, Langwedel (DE)

(73) Assignee: Rheinmetall Landsysteme GmbH, Unterluess (DE)

(21) Appl. No.: 17/119,699

(22) Filed: Dec. 11, 2020

Related U.S. Application Data
(63) Continuation of application No. PCT/EP2019/064601, filed on Jun. 5, 2019.

(30) Foreign Application Priority Data
Jun. 11, 2018 (DE) 10 2018 113 902.0

(51) Int. Cl. B60H 1/34; B60H 1/00

(52) U.S. Cl. CPC B60H 1/3421; B60H 1/00285; B60H 1/00871

(57) ABSTRACT

A device for a ventilation system. An air-conditioning unit comprising a rear wall is arranged such that it is oriented, with the rear wall thereof, towards the module or space to be ventilated such that it is to be reached from said module or space. An interface for air output is arranged on the rear wall, said interface being divided into a plurality of air output points. Said air output points are arranged in different positions on the rear wall. Since all of the air output points do not need to be used, a controller for controlling the air output, which can prevent or enable the air output at the air output points, are associated with the air output points.

This nonprovisional application is a continuation of International Application No. PCT/EP2019/064601, which was filed on Jun. 5, 2019, and which claims priority to German Patent Application No. 10 2018 113 902.0, which was filed in Germany on Jun. 11, 2018, and which are both herein incorporated by reference.

### BACKGROUND OF THE INVENTION

### Field of the Invention

The present invention relates to an apparatus for a ventilation system, as is preferably used in vehicles. Treated air is intended to be provided in the vehicle interior or in other spaces by the ventilation system. Particularly preferably, the apparatus is suitable for use in combat vehicles.

### Description of the Background Art

Conventionally, air treatment is realized by way of an air-conditioning unit which can treat or cool the air and provide the thus cooled or treated air to the vehicle.

Modern vehicles or other applications for such an apparatus are of modular construction, such that the air, which is provided to the vehicle by the apparatus, is intended to be made available in different modules. In order to be made available in various modules, it is necessary to provide a connecting point via which the treated air of the apparatus can be supplied to the modules to be ventilated.

For this purpose, use is conventionally made of a ventilation system which is composed of frequently multi-part tubes and air ducts, which are fed in a branched manner to the individual modules and which originate at the air-conditioning unit. The treated air of the air-conditioning unit is then provided to said ventilation system via the aforementioned interface.

A disadvantage here is that it is necessary for the modules which are intended to be supplied with air to have a uniform interface in order to be able to receive air supplied by the air-conditioning unit. As a result, it is necessary for a uniform position of the interface to be defined, said position needing to be maintained both at the air-conditioning unit and in the modules which are intended to be ventilated.

### SUMMARY OF THE INVENTION

The disadvantages noted above are intended to be avoided or at least alleviated with the present invention. It is thus an object of the present invention to provide an apparatus for a ventilation system which can be contacted by interfaces at different positions and can thus supply air to different modules.

The present invention proposes an apparatus for a ventilation system, said apparatus comprising an air-conditioning unit which at least adjoins, or partially projects into, the module to be ventilated. To this end, the air-conditioning unit has a rear wall which either adjoins the module to be ventilated in such a way that the rear wall is freely accessible from the module or the rear wall projects, at least in certain regions, into the module.

An interface for discharging air is then arranged on the rear wall, wherein said interface is divided into a plurality of air discharge points. The air discharge points are preferably realized alongside one another, with the result that a long row of air discharge points is produced. The air discharge points are thus arranged at various positions of the rear wall.

It is then possible, at these air discharge points, to discharge the air to the corresponding module to be ventilated, resulting in the possibility of in each case arranging the air inlet with respect to the individual modules at different points on the module, with the specification that the individual points are adapted to at least one air discharge point of the apparatus according to the invention.

According to the invention, the air discharge points are provided with a controller to control the discharge of air, said controller being able to control the discharge of air in such a way that the discharge of air can be prevented or enabled at the individual air discharge points. Intermediate positions, that is to say a reduced discharge of air, are also conceivable here.

In the simplest form, said means for controlling the discharge of air can be composed of panels which can be arranged at the individual air discharge points. The panels are arranged such that the air discharge points can be closed by the panels. In the case of the aforementioned long row of air discharge points, it is therefore advisable to close those air discharge points which are not required for the discharge of air by way of corresponding means for controlling the discharge of air and to correspondingly open the rest of the air discharge points by removing the means.

An air conductor, which can direct the air discharged by the air-conditioning unit into the module intended for ventilation, can be connected to the air discharge points. According to the invention, these air conductor can be embodied in various ways.

In an embodiment, the air conductor is in this case embodied as a ventilation shaft. Said ventilation shaft is rigid and produced from solid materials, such as plastic or metal. The ventilation shafts are designed such that they conduct the air from the air-conditioning unit used to the corresponding point in the module.

The air conductor can also be embodied as a tube, said tube for example likewise being able to be composed of plastic or of a textile. Compared with the ventilation shafts, this form of air conductor has the advantage that it can be placed in a more flexible manner into the regions in which the discharge of air is intended to take place.

The controller for controlling the discharge of air can be manually actuated, for example as mentioned above by attaching or removing panels. However, in one particular embodiment, the controller for controlling the discharge of air are designed such that the corresponding means are automatically actuated when the air conductor is connected. This means that when the air conductor is connected, the discharge of air is automatically enabled, and therefore it is made possible to supply air to the air conductor, and that when the air conductor is removed, the respective air discharge points are automatically closed, and therefore the discharge of air is prevented.

It is proposed that the air conductor has at least one air outlet so that the air from the air-conditioning system can be supplied to the module to be ventilated and can also be discharged there. The air outlet can be designed such that it is constantly open. However, it can also be designed such that the air outlet can be controlled. This means that a regulator can be provided at the air outlet, said regulator being able to regulate the air flow at the air outlet. For this purpose, it is alternatively also possible for the air flow to be completely stopped. Any desired position between these two options is possible.

It is proposed for the air outlet to be made for example of air-permeable textile or, in order to realize the aforementioned regulating function, to be formed of at least one ventilation grille. Said ventilation grille can then regulate the air flow, as mentioned above, for example by way of a slide regulator. It is possible for the slide regulator to be controlled in an automated manner, that is to say electrically, or else manually via a mechanical lever.

In order to be able to perform maintenance on the apparatus in the installed state, it is proposed for at least one maintenance flap to be provided on the rear wall of the air-conditioning unit. These maintenance flaps then make it possible to perform maintenance work on the air-conditioning unit. The maintenance flaps can also be designed such that it is possible for personnel to climb through them. This is advisable in the case of very large air-conditioning units.

In a further preferred embodiment, it is proposed that the ventilation shafts have fastening points when said ventilation shafts are used. Additional elements of the air-controlling arrangement could be attached at these fastening points, such as, for example, an air-distributor. However, the fastening points can also be used to fasten the ventilation shafts themselves in the module to be ventilated.

The aforementioned fastening points can be realized by simple screw connection, but latching and adhesive bonding are also conceivable.

Since it is likewise intended to be possible to discharge air to a plurality of modules, it is proposed for the apparatus according to the invention to be provided with an extension. In this case, the extension is arranged not on the rear wall of the air-conditioning unit but rather outside of said rear wall. To this end, the extension has further air discharge points, which are preferably likewise realized alongside one another in the form of a row. The extension is connected to the air-conditioning unit, preferably by way of a leadthrough line, so that it is also possible to enable said air discharge points to discharge air. Said leadthrough line can be of rigid or flexible embodiment and it can be connected to a connection, specially provided therefor, of the air-conditioning unit or else to the aforementioned air discharge points on the rear wall of the air-conditioning unit. In this way, it is possible to also enable air to be distributed into modules which are sealed off from the rear wall.

By way of example, in a vehicle, it might be the case that the supply of air is desired in two different modules, the two modules being sealed off from one another. Here, it would then be made possible to supply air in the first module through the air discharge points on the rear wall of the air-conditioning unit, and the supply of air in the module sealed off therefrom would be ensured by way of the extension.

Furthermore, in one particular embodiment, it is proposed for an air-distributor to be arranged on the air conductor. Said air-distributor can be fastened for example by way of the fastening points or else can be fixedly connected to the air conductor. Here, it is for example possible for roof ventilation to be realized. To this end, an air conductor is connected to at least one air discharge point and an air-distributor is assigned to the air conductor. The air-distributor is then arranged on the ceiling of the module to be ventilated and likewise has at least one air outlet. Said air outlet can, as mentioned above, be made of air-permeable textiles or other corresponding air-permeable elements.

Particularly preferably, it is furthermore proposed for a closable opening to be assigned to the air-distributor. As a result, it is possible for a stronger air flow to be generated, as desired, in a selective manner in the module to be ventilated. The closable opening can in this case be realized by flaps or in the case of a textile-like air-distributor by regions with a respective zip fastener.

Preferably, the air-conditioning unit can also be assigned an air-treatment which treats the cooled air before said air is discharged to the module to be ventilated. Here, ABC filters are conceivable, for example.

For better adaptation of the various modules to the air discharge points, it is proposed for the interface with the individual air discharge points to be divided so as to have a unit spacing, such that the air discharge points are arranged at defined positions.

As a result of the various possibilities for discharging air and the various embodiments of an air conductor, there are therefore a multiplicity of possibilities for ventilating corresponding modules. Thus, not only can air be conducted at various locations into modules to be ventilated, but active ventilation of seats in a vehicle is also made possible as a result.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective illustration of the apparatus with use of ventilation shafts; and

FIG. 2 shows a perspective illustration of the apparatus with use of an air-distributor.

### DETAILED DESCRIPTION

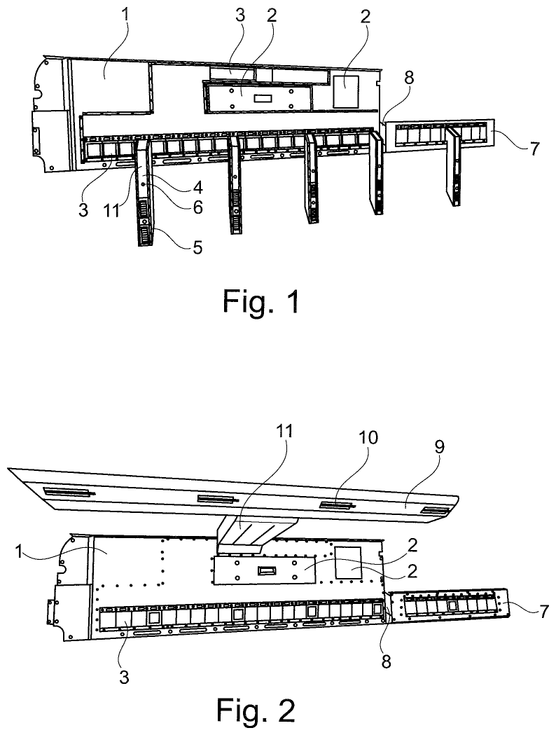

FIG. 1 shows the apparatus according to the invention for a ventilation system, wherein, here, the air-conditioning unit used is shown with a rear wall one the rear wall 12 in this case with respect to the module to be ventilated

An interface 3 is arranged on the rear wall 1, said interface being used to discharge air of an air-conditioning unit.

However, the interface 3 is divided into air discharge points which are preferably arranged alongside one another, with the result that the interface 3 forms a long row. The air discharge points as well as the interface are thus arranged on the rear wall of the air-conditioning unit.

Furthermore, the air discharge points have a controller for controlling the discharge of air, said controller being able to prevent or enable the discharge of air at the individual air discharge points. An intermediate position is also possible.

Air conductor 11 can be connected to the individual air discharge points. In FIG. 1, air conductor 11 are shown in the form of ventilation shafts 4. The ventilation shafts 4 are arranged at various air discharge points, such that air can be directed from the air-conditioning unit through the ventilation shafts 4 at various locations in the module to be ventilated.

A controller for controlling the discharge of air is provided so that the discharge of air takes place only at the air discharge points which are in use and there is thus no air flow at the air discharge points which are not in use. Said controller can be actuated manually or automatically.

Manual actuation means that the individual air discharge points can be manually blocked or freed. In the simplest form, this is possible by way of panels which are arranged at the air discharge points. Automatic actuation is for example possible in that the controller is arranged at the air discharge points in such a way that said controller, when the air conductor is connected, free the air discharge points and, when said air conductor is removed, block said air discharge points.

For simple maintenance of the air-conditioning unit, it is proposed for the rear wall 1 of the air-conditioning unit to be provided with maintenance flaps 2, such that the air-conditioning unit can also be reached from the module to be ventilated in order to perform maintenance on said unit. The maintenance flaps 2 proposed therefor are arranged on the rear wall 1 of the air-conditioning unit.

The air conductor 11, in this case shown in the form of ventilation shafts 4, preferably have an air outlet 5. Said outlet can be composed of air-permeable textile. However, in the present embodiment in the form of ventilation shafts 4, it is proposed for at least one ventilation grille to be used as air outlet 5. This has the advantage that the ventilation grille can also be controlled, and this makes it possible to enable or block the flow of air through the ventilation grille. Intermediate positions are also conceivable here.

As assembly aid, the ventilation shafts 4 preferably have fastening points 6 via which the ventilation shafts 4 can be attached in the module to be ventilated. Further air-distributor 9 can also be fastened to the ventilation shaft 4 via the fastening points.

An extension 7 of the apparatus according to the invention is likewise shown, whereby air discharge points can also be provided in modules which do not reach the rear wall 1 of the air-conditioning unit. To this end, the extension 7 is introduced in the module to be ventilated, which is provided therefor, and said extension is preferably connected to the air-conditioning unit via a leadthrough line 8. As a result, the supply of air can be supplied to a module not only via the air discharge points in the rear wall 1 of the air-conditioning unit but also via the air discharge points of the extension 7.

Moreover, FIG. 2 shows an air-distributor 9, which is likewise connected, at the rear wall 1, to the air-conditioning unit and which realizes the supply of air via an air conductor 11.

By way of example, said air-distributor 9 can be used to reach further regions in the vehicle. It is thus also possible to use the air for seat ventilation.

Preferably, it is proposed for the air-distributor 9 to be made of textile, wherein the air outlet 5 can then be realized by way of air-permeable material.

Furthermore, closable openings 10 are proposed, which can be assigned to the air-distributor 9. Via said openings, it is possible to increase the air flow at specific locations in a selective manner. Here, FIG. 2 shows that the openings 10 can be composed of zip fasteners. Said zip fasteners can be opened during use, in order to thus generate a stronger air flow, or can be closed, such that there is no air flow through the openings 10.

The present invention is not limited to the embodiments mentioned above. Rather, further embodiments are conceivable. It is thus possible to connect branched air conductor to the apparatus in order to reach more locations in the module to be ventilated. The air discharge points could likewise be of circular design instead of rectangular.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An apparatus for a ventilation system, the apparatus comprising:
an air-conditioning unit which comprises a rear wall;
an interface for discharging air arranged on the rear wall, the interface being divided into a plurality of air discharge points,
wherein the air discharge points are arranged at various positions of the rear wall, and
wherein the air discharge points are assigned a controller to control the discharge of air, the controller being able to prevent or enable the discharge of air at the air discharge points.

2. The apparatus as claimed in claim 1, wherein the controller for controlling the discharge of air is composed of panels which can close the individual air discharge points.

3. The apparatus as claimed in claim 1, wherein at least one air conductor is connected to the air discharge points.

4. The apparatus as claimed in claim 3, wherein the air conductor is a ventilation shaft.

5. The apparatus as claimed in claim 1, wherein the controller for controlling the discharge of air is adapted to be manually actuated.

6. The apparatus as claimed in claim 3, wherein the controller for controlling the discharge of air is automatically actuated when air conductor are connected.

7. The apparatus as claimed in claim 1, wherein at least one maintenance flap is arranged on the rear wall.

8. The apparatus as claimed in claim 3, wherein the air conductor has at least one air outlet.

9. The apparatus as claimed in claim 8, wherein the air outlet is composed of air-permeable textile.

10. The apparatus as claimed in claim 8, wherein the air outlet is composed of at least one ventilation grille which regulates the air flow.

11. The apparatus as claimed in claim 4, wherein the ventilation shaft has fastening points.

12. The apparatus as claimed in claim 1, wherein the interface, by way of at least one extension, provides additional air discharge points which can be arranged outside of the rear wall.

13. The apparatus as claimed in claim 12, wherein the extension is connected to the air-conditioning unit by way of a leadthrough line.

14. The apparatus as claimed in claim 1, wherein an air-distributor is arranged on an air conductor.

15. The apparatus as claimed in claim 14, wherein at least one closable opening is assigned to the air-distributor.
